(19) United States
(12) Patent Application Publication
(10) Pub. No.: US 2026/0074785 A1
(43) Pub. Date: Mar. 12, 2026

(54) Multi-span OSNR and GSNR Prediction Using Cascaded Learning

(71) Applicant: NEC Laboratories America, Inc., Princeton, NJ (US)

(72) Inventors: Giacomo Borraccini, Princeton, NJ (US); Andrea D'Amico, Plainsboro Township, NJ (US); Yue-Kai Huang, Princeton, NJ (US); Zehao Wang, Durham, NC (US)

(73) Assignee: NEC Laboratories America, Inc., Princeton, NJ (US)

(21) Appl. No.: 19/325,431

(22) Filed: Sep. 10, 2025

Related U.S. Application Data
(60) Provisional application No. 63/692,787, filed on Sep. 10, 2024.
(60) Provisional application No. 63/708,303, filed on Oct. 17, 2024.

(51) Int. Cl. H04B 10/079

(52) U.S. Cl. CPC H04B 10/07953

(57) ABSTRACT

Disclosed is a method of cascaded learning applied to GSNR prediction using component optical amplifier, fiber, and transceiver models. The component models are measured and trained separately, before the devices are deployed into the field. Specifically, amplifier and transceiver model are trained based on measurement data, and fiber nonlinearity model are trained based on the synthesis data generated by a Gaussian Noise (GN) model. The optical link model contains all three component models and connects them as the physical order in the optical link. A small number of end-to-end measurements are used to train the optical link model to reduce the accumulated loss and adapt the model to the physical multi-span link.

### CROSS REFERENCE TO RELATED APPLICATIONS

This application claims the benefit of U.S. Provisional Patent Application Ser. No. 63/692,787 filed Sep. 10, 2024, and U.S. Provisional Patent Application Ser. No. 63/708,303 filed Oct. 17, 2024, the entire contents of each of which is incorporated by reference as if set forth at length herein.

### FIELD OF THE INVENTION

This application relates generally to optical communications technologies and networks constructed therefrom. More particularly, it pertains to methods providing general signal-to-noise ratio (GSNR) prediction using cascaded learning for a multi-span optical system.

### BACKGROUND OF THE INVENTION

Accurate estimation of end-to-end optical link performance such as optical signal-to-noise ratio (OSNR) is important for guaranteed quality of transmission (QoT) as well as network planning, maintenance, and configuration. Once the optical link is established, limited time remains for the service provider to measure each wavelength channel's quality and adjust the channel to its max transmission throughput. For a multi-span optical link with various optical components, there are two main methods to predict the end-to-end link performance. The first method is via the direct cascade of component-level models, each corresponding to different link components, with proper calibrations. These include a range of mathematical, statistical, and machine learning (ML-) based models. The direct cascade method doesn't require optical link measurement, but the component models' error accumulated along the link. The second method is to treat the entire multi-span link as a single entity and characterize the link using an end-to-end (E2E) model. This method has high accuracy but requires a large amount of link measurements, which is impractical as the link needs to be established within the required time. The problem in the optical link modeling is how to balance the link measurement time and model accuracy, achieving reasonable channel quality prediction accuracy and minimize the link measurement time.

### SUMMARY OF THE INVENTION

The above problem is solved and an advance in the art is made according to aspects of the present disclosure directed to cascaded learning is applied to GSNR prediction using component optical amplifier, fiber, and transceiver models. The component models are measured and trained separately, before the devices are deployed into the field.

Specifically, amplifier and transceiver model are trained based on measurement data, and fiber nonlinearity model are trained based on the synthesis data generated by a Gaussian Noise (GN) model. The optical link model contains all three component models and connects them as the physical order in the optical link. A small number of end-to-end measurements are used to train the optical link model to reduce the accumulated loss and adapt the model to the physical multi-span link

As will become apparent to those skilled in the art, our cascaded learning framework combines the advantages of both component model and end-to-end measurements. It has knowledge from component models for amplifier/fiber/transceiver which reduces the end-to-end measurement requirements. The end-to-end measurements, on the other hand, help adapt the model to the link and reduce the accumulated errors. The feature of this invention reduces the link measurement requirements but also maintains the link prediction accuracy, with robustness of various channel loading conditions.

### BRIEF DESCRIPTION OF THE DRAWING

FIG. 1 shows a schematic diagram of an illustrative topology for a multi-span optical transmission system.

FIG. 2 shows a schematic diagram of an illustrative optical link model that leverages three component level models according to aspects of the present invention.

FIG. 3 shows a schematic block diagram of an illustrative erbium-doped fiber amplifier (EDFA) gain and noise figure profile for a component model according to aspects of the present disclosure.

FIG. 4 shows a schematic of an illustrative fully connected layer-based neural network for EDFA gain and noise prediction according to aspects of the present invention.

FIG. 5 shows a schematic of an optical link model connecting different component models and predicting the general signal to noise ratio (GSNR) for each channel according to aspects of the present disclosure.

FIG. 6 shows an illustrative feature diagram in a hierarchical format according to aspects of the present invention.

FIG. 7(A), FIG. 7(B), FIG. 7(C), FIG. 7(D), FIG. 7(E), and FIG. 7(F) show illustrative: FIG. 7(A), component-level fiber nonlinearity model; FIG. 7(B), component-level EDFA gain and noise figure (NF) model; FIG. 7(C), schematic diagram for EDFA measurement; FIG. 7(D), schematic diagram of cascaded learning (CL) framework for multi-span OSNR/GSNR prediction; FIG. 7(E), Multi-span measurement pipeline for background ASE channels' OSNr and 400 GbE channels' GSNR; and FIG. 7(F), example of OSaaS channel loading with four 400 GbE channels and eight ASE channels, all according to aspects of the present disclosure.

FIG. 8(A) and FIG. 8(B), show: FIG. 8(A) E2E link model diagram; and FIG. 8(B) component cascading diagram with insert loss parameter refinement; according to aspects of the present disclosure.

FIG. 9(A), FIG. 9(B), and FIG. 9(C) are plots showing: FIG. 9(A) mean absolute error (MAE) of three DNN-based model's performance on individual devices; FIG. 9(B) different link models' performances with varying training data sizes for a 5-span link; and FIG. 9(C), MAE of OSNR/GSNR prediction for different models under various link settings; according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

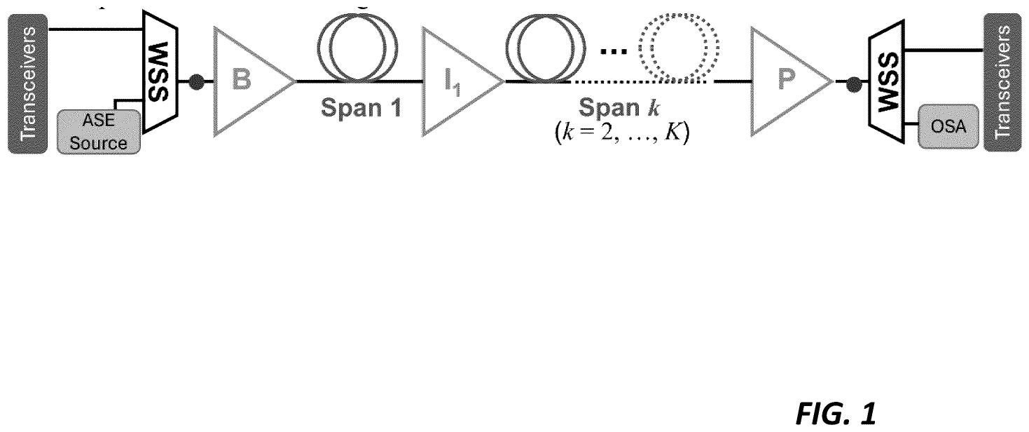

FIG. 1 shows a schematic diagram of an illustrative topology for a multi-span optical transmission system.

With reference to the figure, we note that it shows only I direction of the fiber link the same components/features will be replicated for the opposite direction. The transceivers signals are added to the link at one end of the link via a wavelength selective switch (WSS), which with the pre-amplifiers and boosters are typical optical components inside a reconfigurable optical add/drop multiplexer (ROADM). For channel loading dependent data collection on the component models and end-to-end measurements, our scheme utilizes an amplified spontaneous emission (ASE) source connected to the WSS to emulate dynamic loading WDM channel profile. The MUX WSS combines the transceiver channels together with loading channels and passes it into the booster Erbium-Doped Fiber Amplifier (EDFA). Multiple in-line amplifiers are placed in the link to compensate for the fiber span loss. After multiple-span fiber transmission, the WDM signal enters the pre-amplifier of the destination node, with the channels under test dropped by a DEMUX W SS to the Rx transceivers. An auxiliary optical spectrum analyzer (OSA) is placed at DEMUX WSS side to measure the end-to-end optical signal to noise ratio (OSNR).

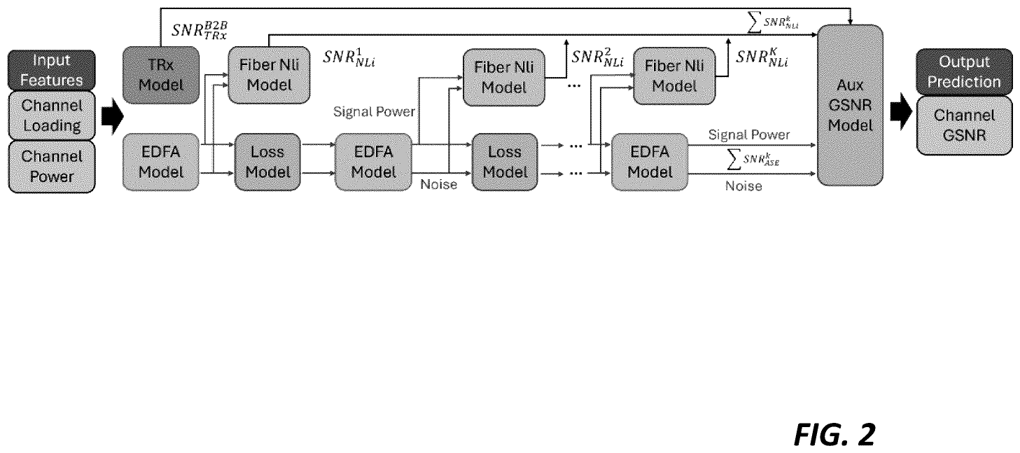

This invention uses three different types of ML-based component level models: EDFA model for gain and noise figure profile prediction, fiber model for non-linearity prediction, and transceiver model for transceiver noise prediction. The EDFA and transceiver models use premeasured data for training, and fiber model uses Gaussian Noise (GN) model for training. After three individual models are trained, they are connected and constructed using the diagram shown in FIG. 2 to form an optical link model.

FIG. 2 shows a schematic diagram of an illustrative optical link model that leverages three component level models according to aspects of the present invention.

With reference to that figure, one may observe that the input features into the optical link model comprises two parts: one-hot channel loading indicator and signal channel powers. The output of the optical link model is the predicted channel GSNRs. The EDFA models are connected as its physical order of EDFA devices in the multi-span link. The loss model (a few untrained fully connected neural network layers) is connected as the output of the EDFA model to represent the span loss and Stimulated Raman Scattering (SRS) effect in the fiber.

The power and noise prediction of the EDFA model are also sent as input of fiber nonlinearity model to calculate the nonlinearity from the fiber. The untrained auxiliary (Aux) GSNR model takes different calculated SNRs, including transceiver, fiber nonlinearity, and ASE, as its input to predict each channel's GSNR.

The training of the optical link model uses Cascaded Learning. First, freeze all the weights in the component level model, use the measured E2E GSNR and input features to train the Aux GSNR and the loss models. Second, unfreeze all the weights and fine-tune the whole link model with the same E2E measurements with a few epochs. After training, the model can predict the channel GSNR under dynamic channel loading condition with known of the signal and noise power at the start of the optical link.

### Step 1: Component Level Model Training

The component level model training takes three different models: EDFA gain and noise figure model, fiber non-linearity model, and transceiver model.

### Step 1.1 EDFA Model

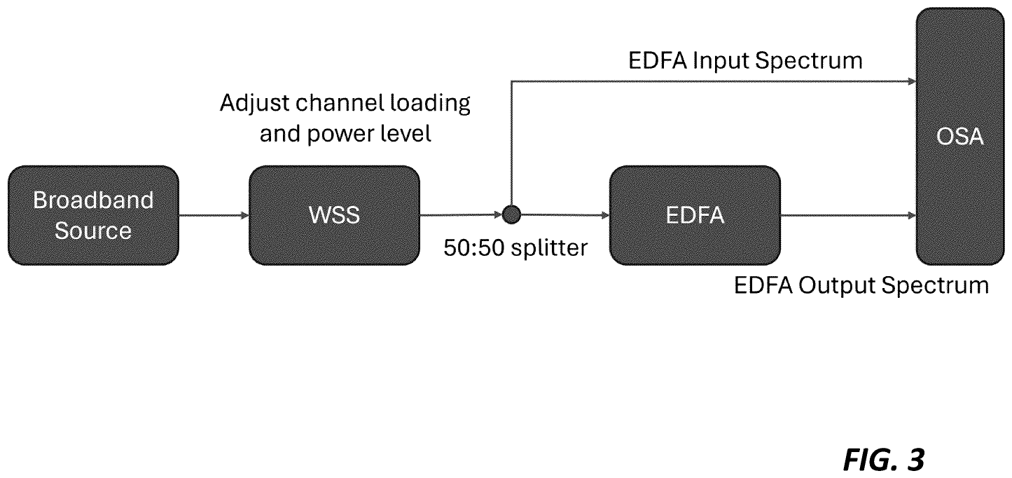

FIG. 3 shows a schematic block diagram of an illustrative erbium-doped fiber amplifier (EDFA) gain and noise figure profile for a component model according to aspects of the present disclosure. The measurement of component EDFA device is as shown in the figure.

Operationally, the broadband source outputs a flattened spectrum with various channel loading to a Ix2 coupler, wherein half of the energy is directed into an OSA for the measurement of input spectrum into the EDFA. Set the designed gain and tilt for the device-under-test (DUT) EDFA, and measure the output of the EDFA using the OSA again. With the input and output spectrum of the EDFA, the wavelength-dependent gain profile and noise figure (NF) can be calculated using standard equations:

$$G ( I ) = 10 logio \frac{pout ( l ) - Nout ( l )}{Pin ( l ) - Nin ( l )}$$

$$NF ( I ) = Pin ( l ) + 58 \; 10 logio \frac{pout}{{}^{p} ASE {(}^{1} )}$$

where P is the channel power and N is the noise level at wavelength 1.

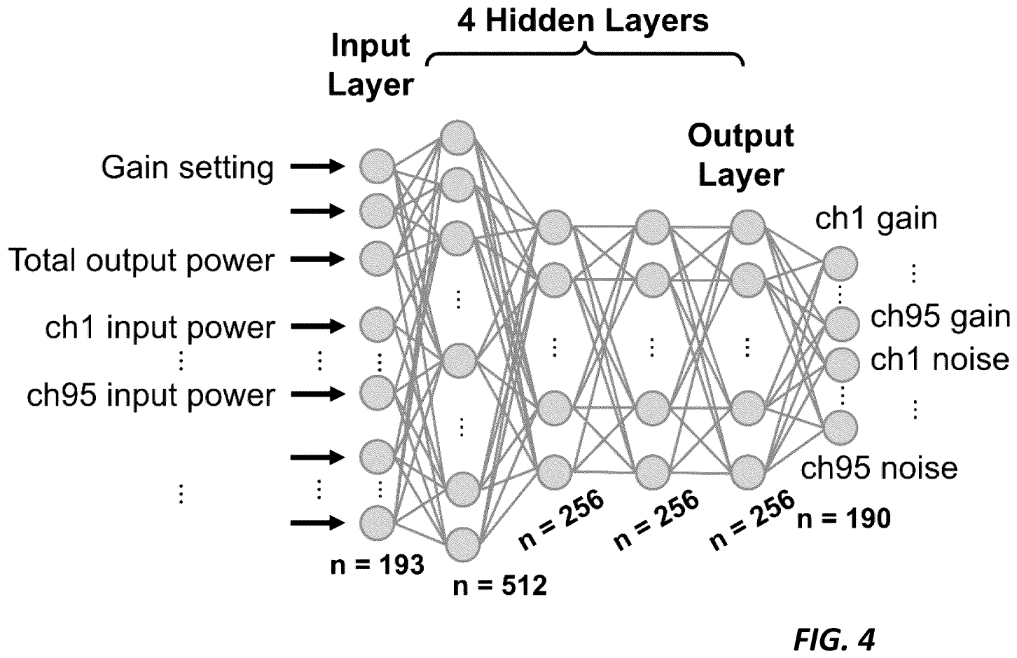

FIG. 4 shows a schematic of an illustrative fully connected layer-based neural network for EDFA gain and noise prediction according to aspects of the present invention. The measurement settings are designed to cover various channel loadings, input power level, EDFA gain, and tilt settings. The recorded measurements are used to train a neural network with fully connected layers, as shown in FIG. 4. The input features are the measurement settings, and the prediction output is the signal gain profile and the noise figure. For the input and hidden layers, we apply batch normalization and use the exponential linear unit (ELU) activation function. We consider the mean squared error (MSE) among loaded channels as the loss function.

### Step 1.2 Fiber Non-Linearity Model

The ML-based fiber non-linearity model has a similar structure to the EDFA model but trained using the synthesis data generated by GN model. The GN model is considered quite accurate but unable to be retrained using the ML back propagation method. We use this step to transfer the GN-based analytical model to ML-based model for the later Cascaded Learning. We consider different settings such as different fiber lengths, insert losses, loss coefficients, channel loading, and input power level for the GN model to generate the non-linearity values as the synthetic dataset to train ML model, using the same activation and loss function as described in the EDFA model. Each trained fiber non-linearity model corresponds to model one physical fiber in the multi-span link.

### Step 1.3 Transceiver Model

The transceiver model is relatively simple compared to the EDFA and fiber model. It only requires back-to-back (BtB) measurements of two transceivers with different Tx power levels across different wavelength channels. There is no neural network related to this model. The transceiver model returns the premeasured transceiver SNR with the input wavelength and Rx received power.

Step 2: Cascaded Learning with the E2E Multi-Span Measurement

The optical link model is constructed using the three component models with their physical order in the link. A few end-to-end measurements are used to train the optical link model to adapt it to the link

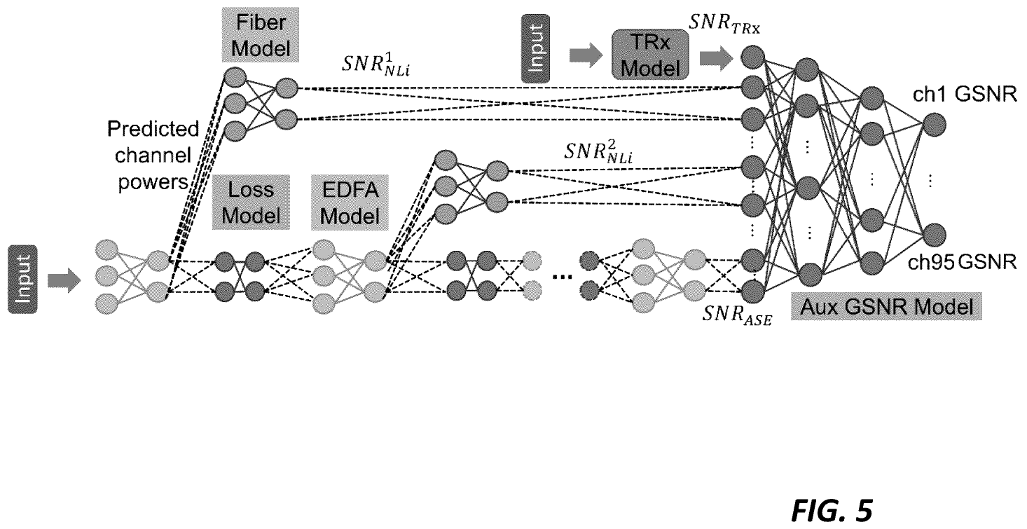

FIG. 5 shows a schematic of an optical link model connecting different component models and predicting the general signal to noise ratio (GSNR) for each channel according to aspects of the present disclosure.

### Step 2.1 Optical Link Model

The optical link model includes the pre-trained EDFA, fiber, and transceiver models, as shown in FIG. 5. The input features include two parts. The first part include transceiver frequencies and Tx powers, which are sent to the transceiver model to calculate the transceiver BtB SNR. The BtB SNR is sent into Aux GSNR model as one input feature. The second part includes channel loading condition, and channel power for each channel, which is sent into the first booster EDFA model.

The output power and noise prediction of the booster EDFA model connects two models: untrained loss model to emulate the insert and fiber loss from the span, and fiber model to predict the non-linearity from the fiber. The predicted non-linearity is directly sent as an input feature into the untrained Aux GSNR model. After the predicted signal and noise after the first booster EDFA propagating through the first loss model, they go into the second in-line EDFA model to predict the output wavelength-dependent signal and noise. The ASE SNR predicted by the last EDFA model will be sent into the Aux GSNR model. The Aux GSNR model predicts each channel's GSNR as the final output of the whole optical link model.

### Step 2.2 Cascaded Learning-Based Link Model Training

To train the optical link model, a small amount of the end-to-end GSNR measurements is collected on the physical link using the OSA and transceivers. The training follows the typical two step cascaded learning process. Firstly, the component model weights are frozen and only aux GSNR and loss models are trained with certain epochs. For the second step, all the weights are unfrozen and fine-tuned using the same end-to-end GSNR measurements. After the training, the optical link model is adapted to the physical link with capability to predict the channel GSNR with input of channel loading condition, channel powers, and noise level.

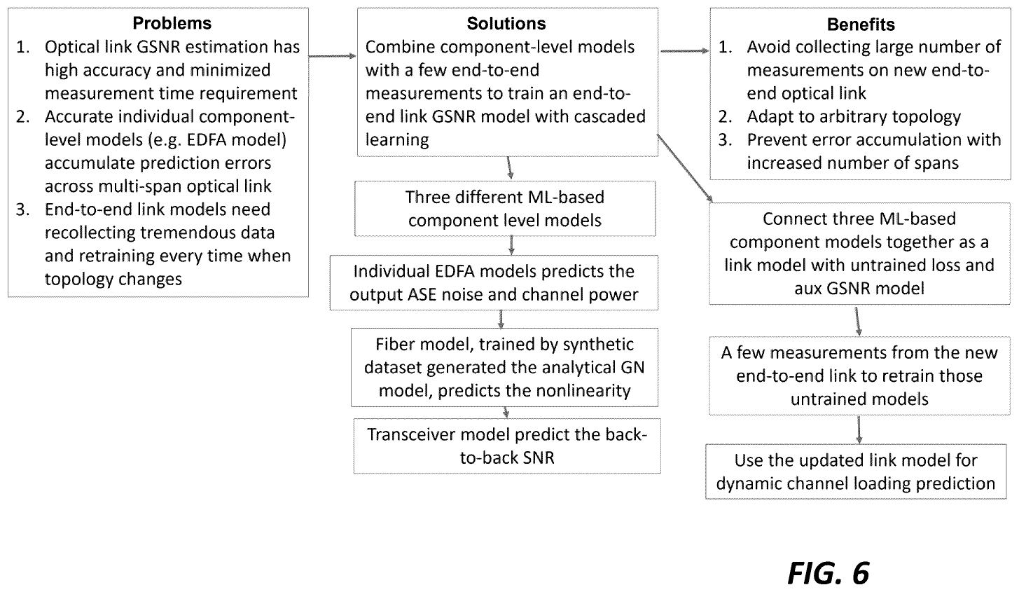

FIG. 6 shows an illustrative feature diagram in a hierarchical format according to aspects of the present invention.

We now describe extending our previously described cascaded learning (CL) framework from multis-span power spectrum to OSNR/GSNR prediction. We combine separately characterized component models including EDFA gain, noise figure (NF), and fiber non-linearity model, with fully connected (FC) layers, whose parameters are trained using end-to-end multi-span link measurements. We verify the performance of CL-based model under three different link configurations with various channel loadings and with a total fiber length of 396 km. We also compare the CL-based method with two baselines: the E2E model and component cascading with parameter refinement. Experimental results show that the CL-based model achieves a mean absolute error (MAE) of 0.20 dB for OSNR and 0.14 dB for GSNR, which is 0.06/0.15 dB and 0.40/1.03 dB smaller compared to the E2E and component cascading method. The CL model only requires 41 end-to-end link measurements and shows adaptation over unseen component device settings.

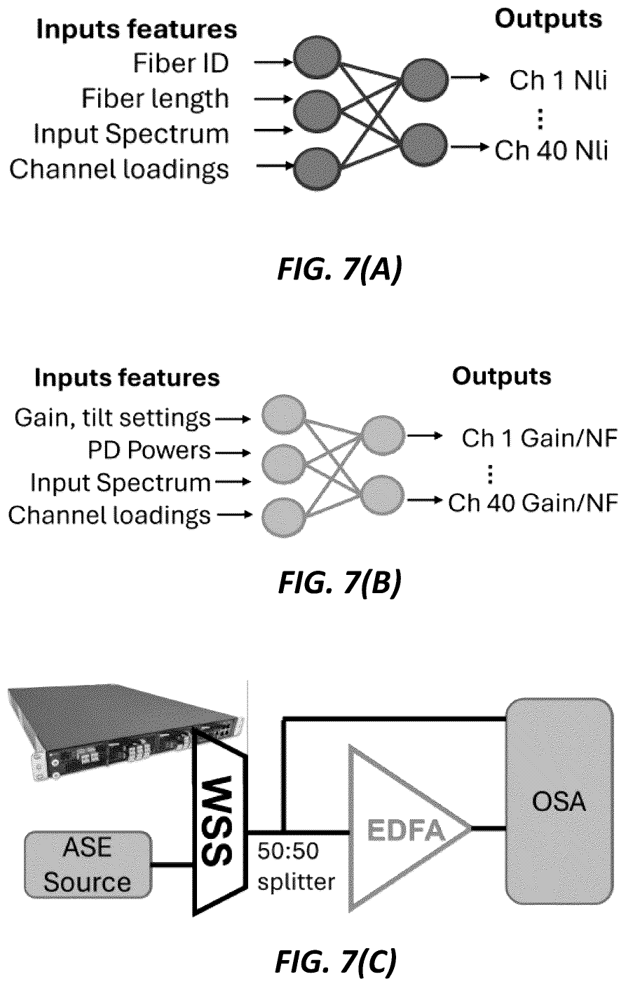

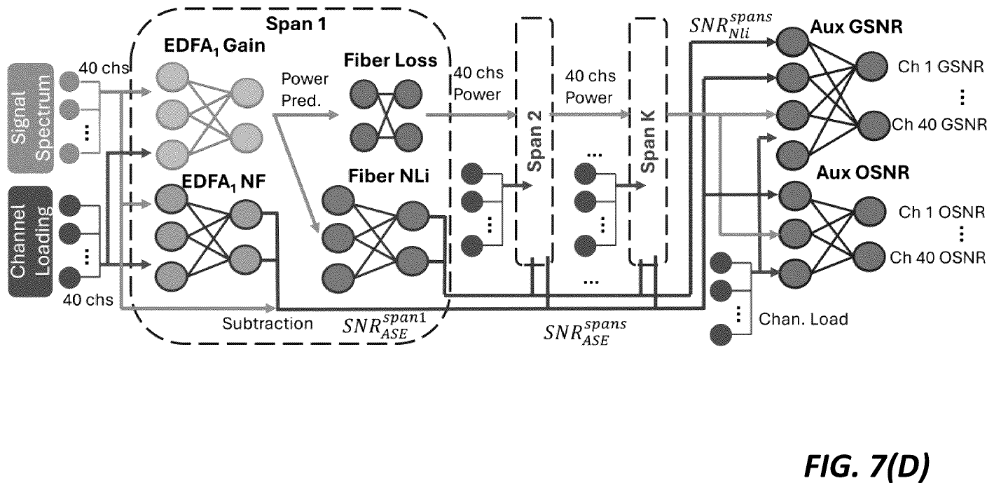

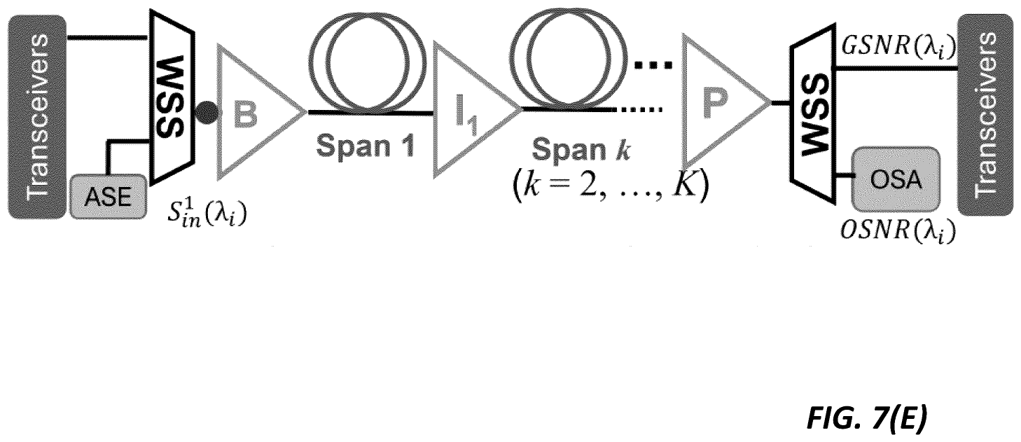

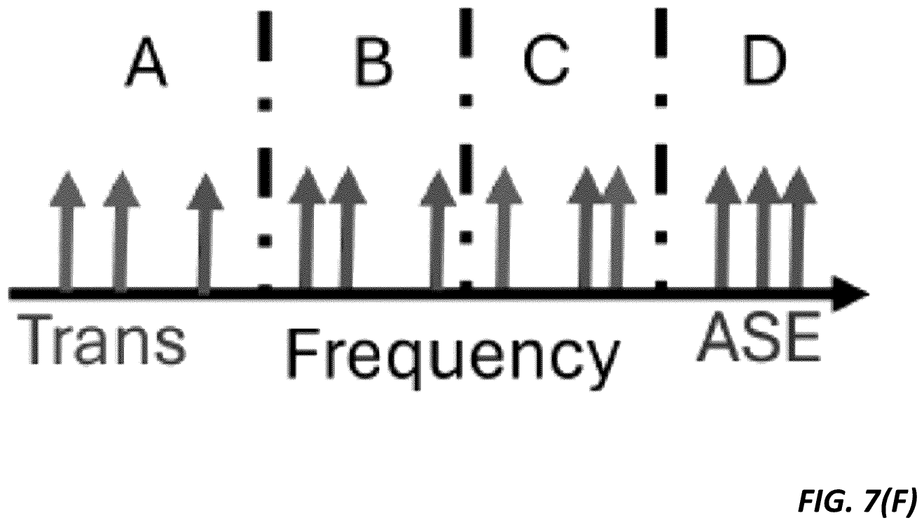

FIG. 7(A), FIG. 7(B), FIG. 7(C), FIG. 7(D), FIG. 7(E), and FIG. 7(F) show illustrative: FIG. 7(A), component-level fiber nonlinearity model; FIG. 7(B), component-level EDFA gain and noise figure (NF) model; FIG. 7(C), schematic diagram for EDFA measurement; FIG. 7(D), schematic diagram of cascaded learning (CL) framework for multi-span OSNR/GSNR prediction; FIG. 7(E), Multi-span measurement pipeline for background ASE channels' OSNr and 400 GbE channels' GSNR; and FIG. 7(F), example of OSaaS channel loading with four 400 GbE channels and eight ASE channels, all according to aspects of the present disclosure.

We consider a multi-span optical link with K spans and K+I EDFAs, as shown in FIG. 7(E). Input channels into the link include signal channels from transceivers and background ASE noise channels from an ASE source. Given the input spectrum before the first booster EDFA SK (AI), the goal is to predict the GSNR (Ai) for transceiver channels and OSNR (Ai) for background ASE channels, after signal propagates K-span link.

Each EDFA in the link is associated with a gain spectrum and a noise figure model. It consists of an input layer, four hidden layers with 128/128/64/64 neurons, and an output layer, with the input and output features shown in FIG. 7(B).

The fiber nonlinearity model contains three hidden layers with 128/64/64 neurons, and the input and output features are shown in FIG. 7(A). Both models use exponential linear unit (ELU) activation functions for the first several layers and do not use activation functions for the last two layers for better regression performance.

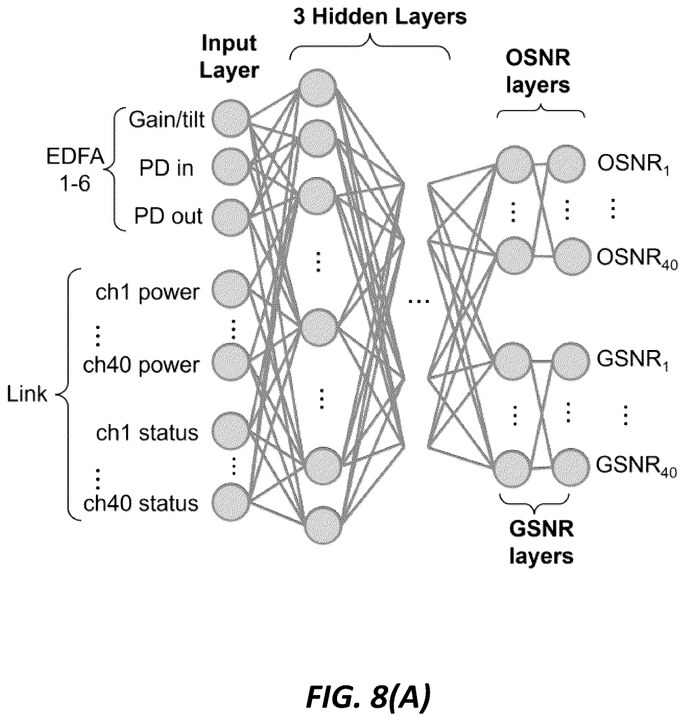

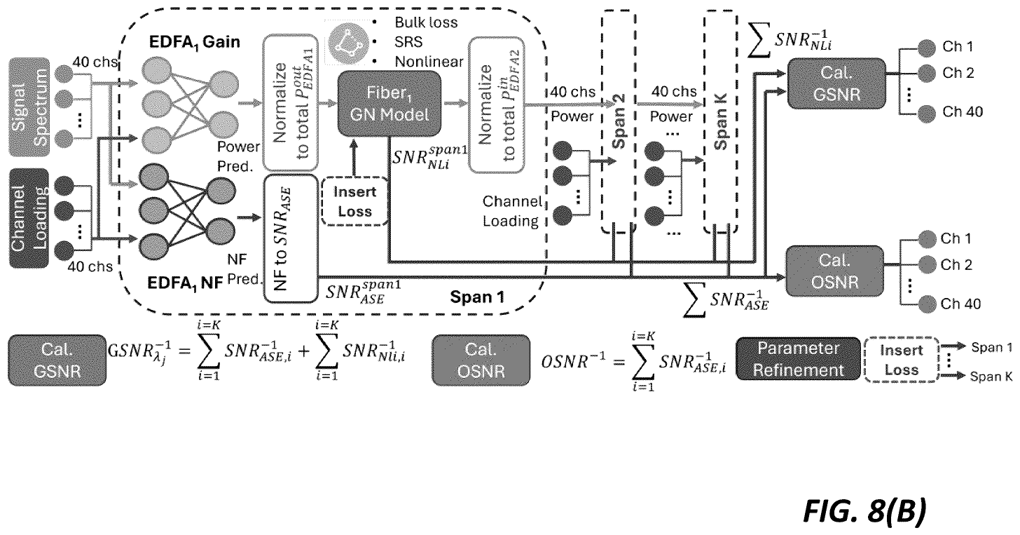

FIG. 8(A) and FIG. 8(B), show: FIG. 8(A) E2E link model diagram; and FIG. 8(B) component cascading diagram with insert loss parameter refinement; according to aspects of the present disclosure.

We consider two approaches for the OSNR/GSNR prediction as baselines: end-to-end (E2E) learning and component cascading with parameter refinement (C-PR). For the E2E link model, it trains a new model based on end-to-end measurements including input power spectrum, channel loading settings, total input and output power at each EDFA, and the EDFA gains and tilts. We implement the E2E model using the DNN architecture with three hidden layers with 128/64/64 neurons and activation function ELU, shown in FIG. 8(A).

The output of the last hidden layer connects to two separate 40 neurons' FC layers without activation function, to predict the link OSNR and GSNR separately. For the component cascading with parameter refinement (C-PR) method, we use the component EDFA models for EDFA gains and noise figure prediction, and GNPy for the fiber nonlinearity and loss calculation, shown in FIG. 8(B).

The input power spectrum is first put into the EDFA gain and NF model, where the predicted NF is used to calculate link OSNR/GSNR, and the predicted EDFA power spectrum is firstly normalized using EDFA PD power reading and then sent into the GNPy. The GNPy-based fiber model calculates the nonlinearity for link GSNR and output spectrum after fiber. The spectrum is normalized again using the next span's EDFA input PD power reading and sent into the next span.

After K-span, the OSNR is calculated using each span's SNRAsE and GSNR is calculated using both SNRAsE and SNRNIi. We use the end-to-end measurement to refine the insert loss of each span, adapting the analytical component fiber model to the link. However, there is no existing method to adapt the NN-based EDFA model, and the error will still accumulate. Our cascaded learning (CL) framework effectively solves the link adaptation for all NN-based component models, compared to the C-PR. It has a similar diagram as C-PR (see FIG. 7(D)), but replaces the GNPy-based fiber model with a pre-trained fiber nonlinear model and a fiber loss model comprising three FC layers for the fiber output spectrum prediction. The auxiliary GSNR and OSNR model at the end takes SNRAsE, SNRNli, predicted spectrum, and channel loading as input and predicts the link GSNR/OSNR. They have the same NN architecture, comprising three FC layers of 40 neurons (WDM channel number) and an ELU activation function at the first layer. Note that the fiber loss and auxiliary OSNR/GSNR models do not need to be trained individually but will be trained as part of the CL-based link model.

### Experimental Setup and Results

We first characterize different individual components in the optical links and then characterize the 5-span links using E2E, CL, and component cascading methods.

### Individual Model Measurements and Training

FIG. 7(C) shows the measurement diagram of individual EDFA. The ASE source is connected to a wavelength selective switch (WSS), which adjusts the channel loadings and power levels. The output signals are split into two routes: one into the EDFA and another into the optical spectrum analyzer (OSA), to measure the input and output spectrum of EDFA.

We applied various EDFA settings including input power levels (−4/−2/0 dBm), gain (15/18/20 dB), tilt (−1 and 0), and dynamic channel loadings. Due to the measurement time limitation, only the first inline amplifier is characterized with full channel loadings of 262 measurements, using a 6 fully connected layers neural network as a base model for training. The other EDFAs are measured with only 40 channel loadings and transferred from the base EDFA model using transfer learning. The train and test split for the EDFA gain and noise figure model is 87:13 and 50:50 for base and transferred model, respectively.

We measure the fiber for the fiber length, loss coefficients, lumped loss, dispersion, etc. Those measured parameters are put into the GNPy for the analytical fiber nonlinearity model, which generates the synthesis data for the NN-based fiber non-linear model training. In GNPy simulation, we select 150 different random channel loadings, with a total launch power from 16.5 to 18 dB with 0.3 dB step to generate the synthesized fiber nonlinearity dataset, where the training set is 3,490 simulations and the test set is 388 measurements for each fiber model. For each transceiver characterization, we measure the OSNR-BER curve with two DCOs connected back-to-back, with OSNR varying from 22.5 to 40.5 dB.

### 3.1. 5-Span Measurements

FIG. 7(E) shows the experimental setup of the 5-span optical link. The NEC Phoenix whitebox transponder comprising of four Lumentum 400 GbE CFP2 digital coherent optics (DCO) pluggable, together with a broadband ASE source, connects to a Nistica MUX wavelength-selective switch (WSS). The WSS consists of 40 channels with 100 GHz channel spacing starting from 191.75 THz.

The MUX WSS flattens the spectrum and transmits the 400G signals together with ASE-emulated background traffic signals through a 5-span link with 6 Molex EDFAs and 5 spans of fiber with a total length of 396 km. The ASE and 400G signals drop to OSA and another whitebox by the Nistica DEMUX WSS to measure the OSNR and BER, respectively. The BER measurement is repeated 10 times for averaging and converted to GSNR by the separately measured back-to-back transceiver characterization. We record the channel loading, input power spectrum, PD powers reading before and after each EDFA, and the GSNR for signal channels and OSNR for ASE channels. We evaluate the proposed method under three different sets of channel loadings and three link settings.

We consider three types of channel loading conditions: (i) full channel loadings, including four transceiver channels index (i, i+4) for i e {1, 5 33, 37}), with other 36 channels loaded with ASE channels; and (ii) fixed channel loadings, including fixed transceiver channels index, 35), and 10 random configurations for ASE channel number n e {5, 10, 15, 20, 25}; and (iii) Optical spectrum as a service (Osaas) loadings.

We divide the spectrum into four groups, each with 10 times100 GHz channels. We put two transceiver channels into one group, and two in the other group. For each group, we randomly load ASE channels to have a total channel number of ntotal e {3, 5, 7} with two random repeats. For example, FIG. 1(f) shows a channel pattern where each group randomly loads with three channels. For each channel loading pattern, we turn on and off groups of channels sequentially to emulate spectrum users' operations. There are 9 different on/off operations including all groups on, one group off, and selected two groups off. The total number of full/fix/Ossas channel loading measurements is 10/100/162, respectively. We consider three different link configurations: SI sets the EDFA gain by 15 or 18 dB with tilt by −I; and S2 reduces 1 dB input power for all channels while remains the gain and tilt settings the same as S I; and S3 remains the channel input power as S 1, and set the gain between 15.6 to 20 dB and tilt to be −2 to compensate the fiber bulk and SRS losses for each span and make launch power the same for all the span.

Component Model Training and Results All fiber component models are trained by an Adam optimizer with a learning rate of le-3 over 1200 epochs. The first inline amplifier model is trained using the learning rate and epochs as the source model. Other amplifier models are transferred from the source model, with the standard TL process. We frozen the first several layers and trained using an Adam optimizer with a learning rate of 2e-4 over 200 epochs. Then we unfrozen all the weights and fine-tuned the model with a learning rate of le-4 over 70 epochs.

FIG. 3(a) shows the component-level models' mean absolute error (MAE) with standard deviation for 6 EDFAs and 5 fibers. The MAE is 0.08, 0.12, and 0.19 dB for EDFA gain profile, noise figure, and fiber nonlinearity, respectively.

### Link Model Training and Training Set Size Selection

The E2E model is directly trained using the end-to-end measurements by an Adam optimizer with a learning rate of 5e-3 over 800 epochs. For C-PR, we use PyCMA to optimize the insert loss with 10 iterations. The CLbased models are trained using a two-step process: First, freeze the weights of all pre-trained component models and train the rest parts using the Adam optimizer with a learning rate of le-2 over 400 epochs. Then, all the weights are unfrozen and fine-tuned using the same end-to-end measurements, with a learning rate of le-3 over.

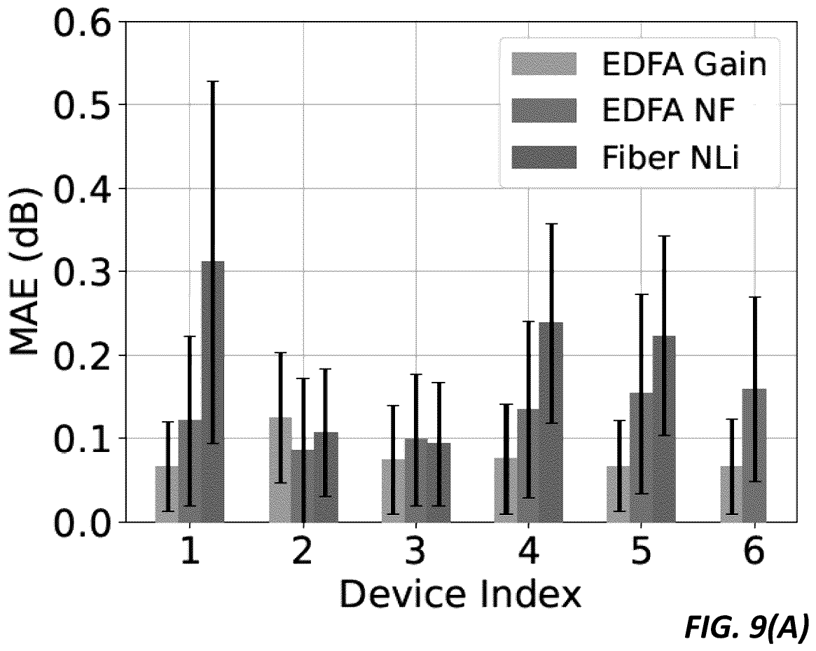

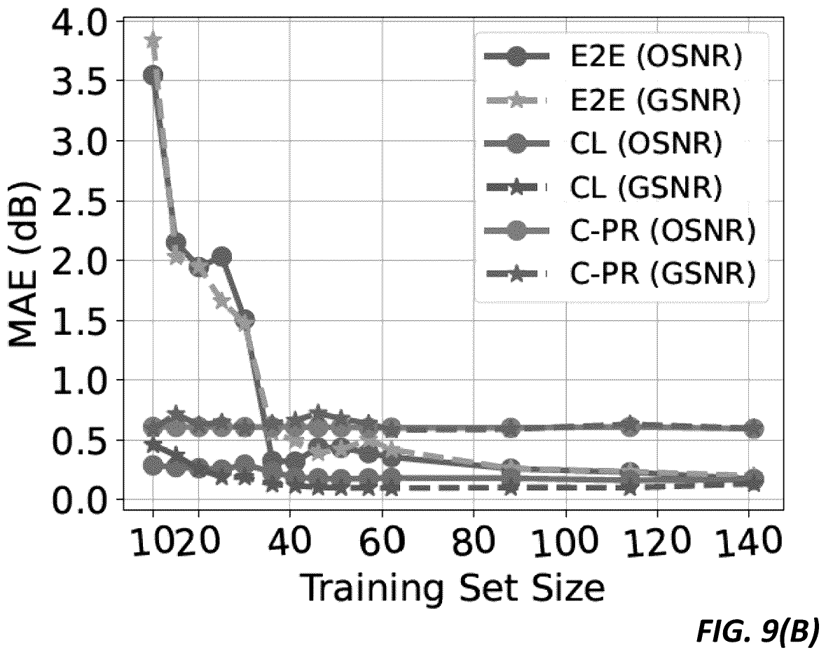

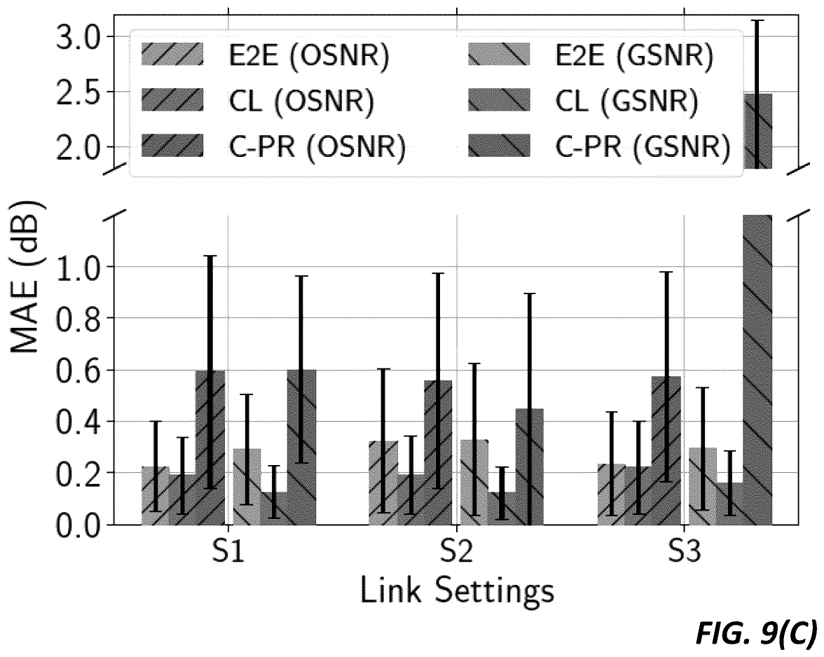

FIG. 9(A), FIG. 9(B), and FIG. 9(C) are plots showing: FIG. 9(A) mean absolute error (MAE) of three DNN-based model's performance on individual devices; FIG. 9(B) different link models' performances with varying training data sizes for a 5-span link; and FIG. 9(C), MAE of OSNR/GSNR prediction for different models under various link settings; according to aspects of the present disclosure.

FIG. 9(B) shows the different model performances under different training set sizes. The minimum training set size is the 10 measurements of the full channel loadings which guarantees GSNR of each channel will be seen by the model at least once. For the E2E model, it has a high MAE under a small training set and has both stable OSNR and GSNR prediction performance when the training set is larger than 88 samples. For the CL model, it achieves 0.29/0.46 dB MAE under the minimized 10 measurements but keeps improving its performance with the training set increases up to 41 samples.

For component cascading, the fiber inset loss refinement improves the GSNR with MAE from 1.2 dB to 0.6 dB, but does not have improvement on the OSNR, as the OSNR curve for Component cascading is overlapped with C-PR. The reason might be OSNR prediction only depends on the EDFA noise figure model, where the model always returns 5-8 dB NF and is less sensitive to the input power level. We empirically select 10/41/88 training samples for C-PR, CL, and E2E models when more training data does not bring performance improvement and use the remained 184 samples as test sets for a fair comparison of different link models.

### 5-Span Prediction Results

FIG. 9(C) shows the MAE of different models' OSNR and GSNR prediction under different link settings. The CL model achieves an MAE of 0.20/0.14 dB OSNR/GSNR averaged on three link settings, with 0.06/0.15 dB lower MAE and only use half of the end-to-end link measurement training data compared to the E2E model. The C-PR achieves 0.57/0.52 dB MAE under the SI and S2 settings on OSNR/GSNR. However, the GSNR prediction gets 2.5 dB on the S3 transparency setting, as the gain/tilt settings are different compared to the one under component device measurement. The E2E and CL model shows better adaptation capability when the component device settings are unseen during the component model training.

Those skilled in the art will appreciate our CL-based framework for multi-span OSNR/GSNR prediction leveraging pre-trained fiber nonlinearity, EDFA gain, and noise figure model with minimized end-to-end measurements. Compared to the E2E learning and component cascading with parameter refinement, we show the CL-based model can achieve an MAE of 0.20/0.14 for OSNR/GSNR prediction across a 5-span link with 6 EDFAs using 41 end-to-end measurements.

While we have presented our inventive concepts and description using specific examples, our invention is not so limited. Accordingly, the scope of our invention should be considered in view of the following claims.

1. A method for predicting end-to-end optical link performance in a multi-span optical network, the method comprising:
training a plurality of component-level models, each corresponding to a different optical component in the network;
constructing an optical link model by connecting the trained component-level models in the physical order of the optical components in the network;
using end-to-end link measurements to train the optical link model to adapt it to the physical multi-span link and reduce accumulated error.

2. The method of claim 1 wherein the plurality of component-level models include an erbium doped fiber amplifier (EDFA) model for predicting gain and noise figures, trained using measured data.

3. The method of claim 2 wherein the plurality of component-level models include a fiber non-linearity model for predicting non-linearity, trained using synthetic data generated by a Gaussian Noise (GN) model.

4. The method of claim 3 wherein plurality of component-level models include a transceiver model for predicting back-to-back SNR, trained using measured data.

5. A computer-implemented method for end-to-end optical network performance prediction, the method comprising:
receiving a plurality of input features for a multi-span optical link, including a channel loading indicator and signal channel powers;
inputting the features into a pre-trained erbium doped fiber amplifier (EDFA) model, a pre-trained fiber non-linearity model, and a pre-trained transceiver model arranged in a cascaded learning framework;
calculating and accumulating noise contributions from the components, including amplified spontaneous emission (ASE) noise from the EDFA model, non-linearity from the fiber model, and back-to-back signal-to-noise ratio (SNR) from the transceiver model;
predicting an end-to-end generalized signal-to-noise ratio (GSNR) for each wavelength channel using an auxiliary GSNR model that receives the calculated noise contributions as input; and
training the auxiliary GSNR model and an untrained loss model within the framework using a limited number of end-to-end measurements to adapt the model to the physical link.
